(19) United States
(12) Patent Application Publication
(10) Pub. No.: US 2015/0134453 A1
(43) Pub. Date: May 14, 2015

(54) System for Providing Information Relating to Points of Interest in Proximity to a Location

(71) Applicant: Pixearch, Inc., Irvine, CA (US)

(72) Inventor: Rishi Jhunjhnuwala, Irvine, CA (US)

(73) Assignee: Pixearch, Inc., Irvine, CA (US)

(21) Appl. No.: 14/078,108

(22) Filed: Nov. 12, 2013

(51) Int. Cl. G06F 17/30; G06Q 30/02

(52) U.S. Cl. CPC G06F 17/30241; G06Q 30/0261
USPC 705/14.58; 707/769; 707/722

(57) ABSTRACT

A system for providing information relating to points of interest located in proximity to where a photo was taken having a server for receiving device location and heading information from a device used to take a photo, the server configured to process the device location and heading information to search for points of interest within a predetermined range of the device location and heading, to collect information relating to the points of interest within the predetermined range of the device location and heading, and to communicate the collected information relating to the points of interest to the device used to take the photo.

### BACKGROUND OF THE INVENTIVE FIELD

Mobile device use has been increasing at a increased pace after the introduction of smartphones, smart-cameras and other “smart” devices connected to a data feed. These machines act as pocket computers for many individuals. With these devices, users are able to access information based upon mobile GPS functionality. Social media applications also hold millions of users captivated on a daily basis with the sharing of photos taken from a mobile device.

The present invention takes the popularity of mobile photo functionality and pairs it with the device's technical capabilities and provides a new experience to users by presenting them with informative content related to the “place” within the captured image by utilizing the location, heading and/or range of the device at the time of the image capture. The process utilized to make this experience possible is based upon the device capabilities and the system architecture. In the preferred embodiment, the mobile device collects the data needed to request relevant “places” information from the server.

### SUMMARY OF THE GENERAL INVENTIVE CONCEPT

The present invention is directed to a system and method of providing place (e.g., business or landmark) relevant information based upon a mobile device's location and heading information. Taking a picture of a landmark or business will return results of information for places related to the area and in proximity to the origination of the image. For example, multiple businesses and landmarks including names, descriptions and other related data may be provided as search results based upon the image's location, heading and/or range. In other words, the search criteria may be based upon the mobile device's location, heading and/or defined ranges at the time of the picture being taken by the mobile user. The user may help define the correct result by confirming a result as a match to the “place” within the picture. Future users who capture photos within that same general proximity will receive refined search results based upon past users' “place” confirmation matches to images. Over time the database query factors will provide users with an experienced sense of image recognition due to potentially more accurate results.

In one embodiment, the present invention is comprised of a computer database for storing information, the database configured to store information relating to points of interest including businesses and landmarks, the database adapted to store for each point of interest the location of the point of interest, and it's name; a server for receiving device location and heading information from a device used to take the photo, the server programmed with one or more software routines executing on the server to: 1) process the device location and heading information to search for points of interest within a predetermined range of the device location and heading; 2) collect information relating to the points of interest within the predetermined range of the device location and heading; 3) communicate the collected information relating to the points of interest to the device used to take the photo.

In the preferred embodiment, the server is programmed with one or more software routines executing on the server to search for points of interest within a predetermined radial range around the location of the device and conical shaped range near the location of the device. The conical range preferably starts from the location of the device and spreads out towards the direction of the heading of the device.

In one embodiment, the system is programmed with one or more software routines executing on the server to accept confirmations from users for points of interest communicated to the devices, to count the number of user confirmations for each point of interest, and to give the points of interest with the highest user confirmations the highest priority in the displayed results.

The system is also preferably configured to accept registrations from businesses and to allow registered businesses to offer deals. The server collects information relating to businesses nearby the predetermined range of the device location and heading that are offering deals to users and communicates the results to the device for display to the user.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates the data used by one embodiment of the present invention to retrieve place relevant information relating to a device;

FIG. 2 illustrates one embodiment of the system of the present invention;

FIG. 3 illustrates a flowchart showing some of the process steps of the present invention;

FIG. 4 illustrates an exemplary screenshot of the present invention illustrating the compass calibration feature;

FIG. 5 illustrates an exemplary screenshot of the present invention illustrating the user interface for taking a photo;

FIG. 6 illustrates an exemplary screenshot of the present invention illustrating how the present invention displays relevant search results;

FIG. 7 illustrates an exemplary screenshot of the present invention illustrating an example of additional details provided for a specific search result;

FIG. 8 illustrates an exemplary screenshot of the present invention illustrating the ability for users to provide reviews for each result;

FIG. 9 illustrates an exemplary screenshot of the present invention illustrating how users can instruct the application to save “favorites” of the search results;

FIG. 10 illustrates an exemplary screenshot of the present invention illustrating the ability to provide additional detail of favorite places;

FIG. 11 illustrates an exemplary screenshot of the present invention illustrating the ability to provide “deals” from businesses that are displayed to the user;

FIG. 12 illustrates an exemplary screenshot of the present invention illustrating the “deals” detail screen where the user can redeem a deal.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

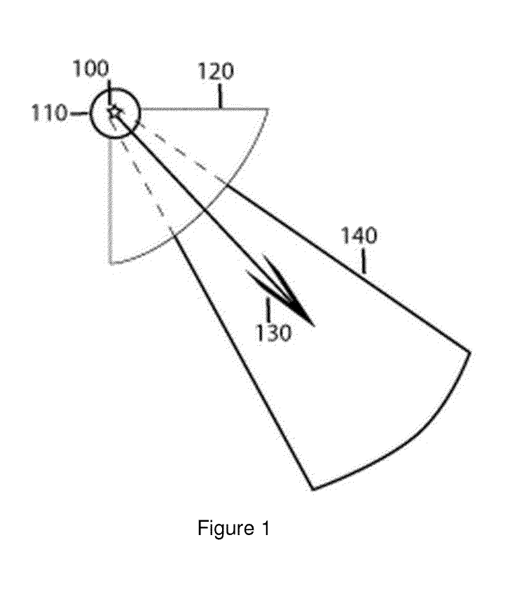

FIG. 1 illustrates the data used by one embodiment of the present invention to retrieve place relevant information relating to a device (e.g., mobile device) of the user taking the photo. In this embodiment, the present invention collects the device's current location (100), the device's heading (130), near/radial range (110), near/wide range (120), and far range (140). The location (100) is preferably determined using the mobile devices GPS latitude and longitude.

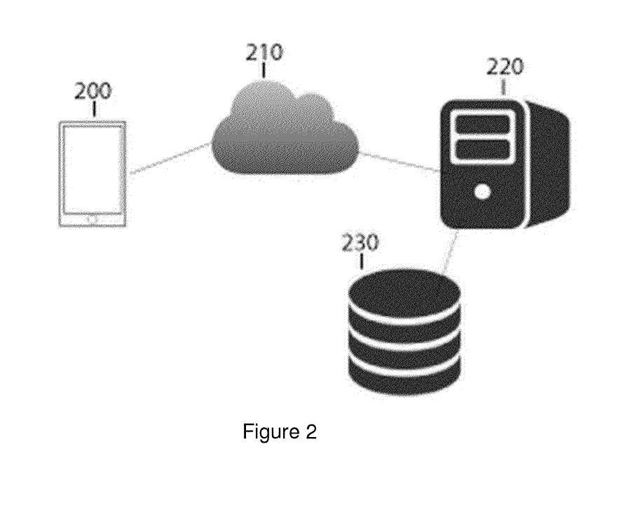

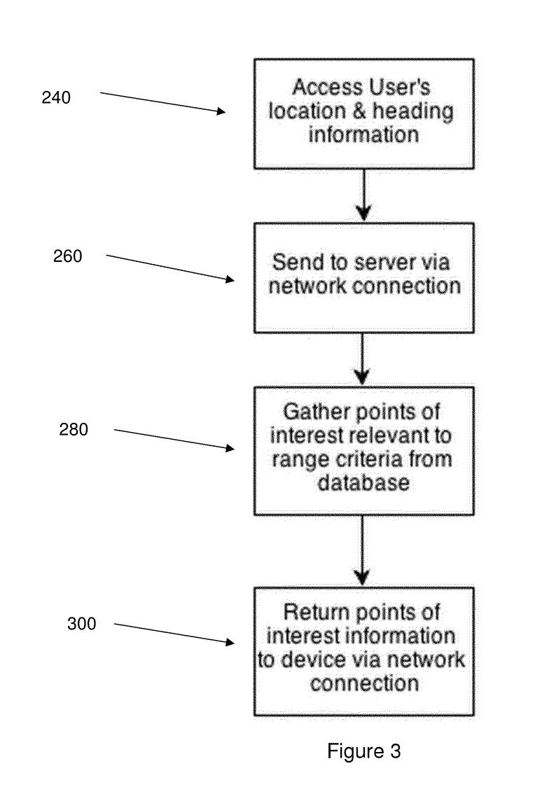

FIG. 2 illustrates one embodiment of the system of the present invention. FIG. 3 illustrates a flowchart showing some of the basic process steps of the present invention. The system of the present invention allows a mobile device (200) to communicate with a server (220) through a WiFi network or data Internet connection (210). The server (220) collects the data from a database (230).

The mobile device (200) collects the device's current location (100) and the device's (200) heading (130)(240) which is adjusted based upon the device's (200) orientation then submits to the server (220)(260) the location (100), heading (130), near/radial range (110), near/wide range (120), and far range (140). The location (100) is determined using the mobile devices (200) GPS latitude and longitude.

In the preferred embodiment, the heading (130) is determined by the device's (200) orientation and the direction that the camera is pointed. The near/radial range (110) is the circular 360 degree radius directly around the mobile device (200) with it acting as the center point based upon the location (100). The near/wide range (120) is the hard coded cone shaped distance reaching out from the device's (200) location (100) as the base of the cone. The far range (140) begins with the device location as the base of the point and stretches out to a further and thinner cone shaped zone distance than the near/wide range (120). The exact distances for each of these ranges can be varied as needed. For example, the ranges can be made smaller for more focused results and made larger for a wider range of results.

After the collection of the location (100), near/radial range (110), near/wide range (120), heading (130), and far range (140), the device (200) communicates these data items to the server (220), preferably via a network connection (210)(260). In the preferred embodiment, the server (220) queries the database (230) for points of interest related to the location (100), heading (130) and range (110, 120, 140) criteria (280).

In one embodiment of the present invention, the server (220), and associated processing system, and database (230) system will determine the relevant points of interest based upon 5 factors and present them to the user (300). These points of interest determining factors are sorted based upon a priority level with the highest level factor being more relevant to the user's experience. These factors, with the highest factor listed first are:
1. Business with confirm count>0 (highest to lowest) (0-500 meters from location);
2. Locations with Wikipedia OR Factual category “Landmark” AND confirm count>0 (Highest to lowest) (0-3200 meters);
3. Businesses with confirm count==0 (0-500 meters);
4. Locations with Wikipedia OR Factual category “Landmark” AND confirm count==0 (0-3200 meters);
5. Businesses with Deals (500-3200 meters) sorted by confirm count (Highest to lowest).

A confirm count is the sum of all users that previously identified a “place” search result as a business or landmark that they were taking a picture of. For example, if a user takes a picture of Alcatraz Island and the results are returned with the Golden Gate Bridge listed first, the user would likely go to the next search result without confirming the result because the Golden Gate Bridge does not match the user's expectation. If the next result is Alcatraz, the user would likely press the “confirm” button displayed by the present invention (in association with the search result) to confirm (i.e., identify) the Alcatraz search result as the place that was the focal point of the user's photo and as the result the user expected.

If within that same general area 100 users take pictures and 70 of them confirm the Alcatraz search result, then the first result listed will be Alcatraz (assuming it has the highest confirm count). If over time 500 users take a picture within that same general area and 350 confirm the Golden Gate Bridge search result and Alcatraz only increased to 100 confirms, then the first result listed by the present invention will now be the Golden Gate Bridge search result. This feature of the present invention allows the users to drive the experience by identifying what they expect as the returned result from their photo. In the preferred embodiment, the server of the present invention will record these confirms and run a calculation after every user photo to then display the sorted results based upon the up-to-date confirm counts.

The first factor queries the database for all points of interest (e.g., business and/or landmark listings) within the database (230) containing a confirm count of greater than zero and that are located within the defined location (100), heading (130) and range (110, 120, 140) and that are no greater than 500 meters from the device's (200) exact location (100). Factor one results are sorted by highest to lowest confirm count. Again, the distance of 500 meters can be changed based the desired focus needed.

The second factor queries the database (230) for all points of interest listings with a confirm count greater than zero and that are located within the defined location (100), heading (130) and range (110, 120, 140) and that are no greater than 3200 meters from the device's (200) exact location (100). Factor two results are sorted by highest to lowest confirm count. Specifically, in one example embodiment, the server (220) receives content from a third party database or service such as Wikipedia and/or Factual to search for relevant points of interest within the range of the device. For example, the server of the present invention calls the Wikipedia API and Factual API to receive content from their databases for latitude and longitudes that reside within the three location/heading defined ranges. That content is then pulled into the database (230) that can be queried for relevant points of interest based upon the search priority list discussed above. For places that exist within the database of the present invention, the Wiki content is preferably merged to those places as the description content. In an alternative embodiment, the server of the present invention can call into the third party services or databases and conduct a direct query of those third party databases to retrieve relevant points of interest to merge into the content of the system database (230).

The third factor queries the database (230) for points of interest listings with a confirm count equal to zero and that are located within the defined location (100), heading (130) and range (110, 120, 140) and that are no greater than 500 meters from the device's (200) exact location (100). Factor three results are sorted by highest to lowest confirm count.

The fourth factor queries the database (230) for points of interest listings with a confirm count equal to zero and that are located within the defined location (100), heading (130) and range (110, 120, 140) and that are no greater than 3200 meters from the device's (200) exact location (100). Factor four results are sorted by highest to lowest confirm count.

The fifth factor queries the database for points of interest listings that contain deals and that are located within the defined location (100), heading (130) and range (110, 120, 140) and that are between the distance of 500 to 3200 meters from the device's (200) exact location (100). Factor five results are sorted by highest to lowest confirm count. Deals are defined as discounted promotions that are generated and published to the database by the business for the purpose of incentivizing the user to become a customer of that business. The server (220) then preferably communicates the points of interest to the mobile device (200) via a network internet connection (210).

In an alternative embodiment, image recognition may be used as part of the process of retrieving relevant search results. For example, image recognition could be added as the first item to the search priority list. The priority given to the image recognition is dependent on the accuracy of the image recognition. If it is extremely accurate then it should receive priority but if it is less accurate than it should receive a lower priority. It is also appreciated that image recognition may work better as a hybrid blended into each method on the priority list. E.g., add image recognition as a requirement to each existing item within the priority list. Image recognition results can also be categorized outside of the current 5 step classification where the results are presented to user as a separate category of results.

In the preferred embodiment, information relating to nearby business are preferably retrieved and presented to the user, along with relevant data including, but not limited to, name, address, telephone number, photos of the point of interest and user reviews. It is also appreciated that advertisements relating to the business may also be displayed. E.g., a business can register with the system of the present invention to provide deals within the application. For example, if a user creates a deal for business XYZ, then that deal is displayed within the ad tile presented by the present invention for business XYZ.

Separately, the last item within the search priority list may also refer to businesses that have ads but do not match the requirements of the other search priority list items. Those businesses will display last within the search results and are there to act as impressions only because they most likely don't match the user's photo. Nearby places preferably consist of ads placed by registered businesses that have defined category(s). For example a business can create an ad and define categories for the ad. If the business is nearby, their ad can show in “Nearby Places” of other locations that are of a matching category defined within the ad.

The screenshot images of the Figures illustrate the user interactions with the mobile application. These screenshots represent an example embodiment illustrating one type of user interface and user experience. The examples do not limit other design and flow potentials for mobile applications that would use the patented technical process.

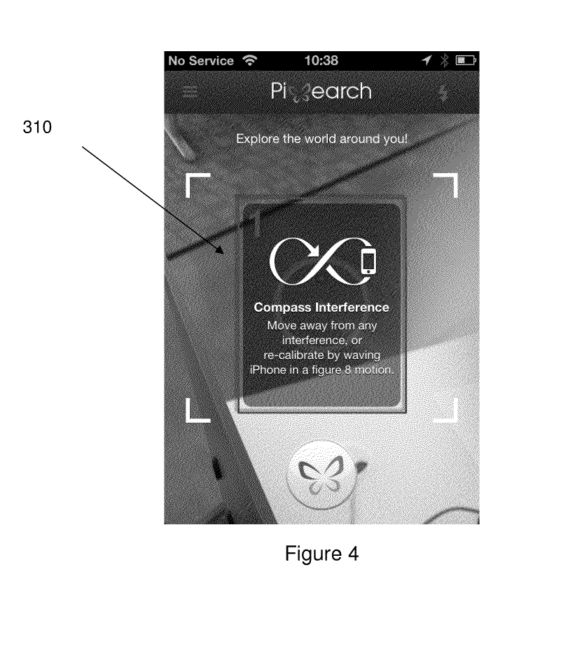

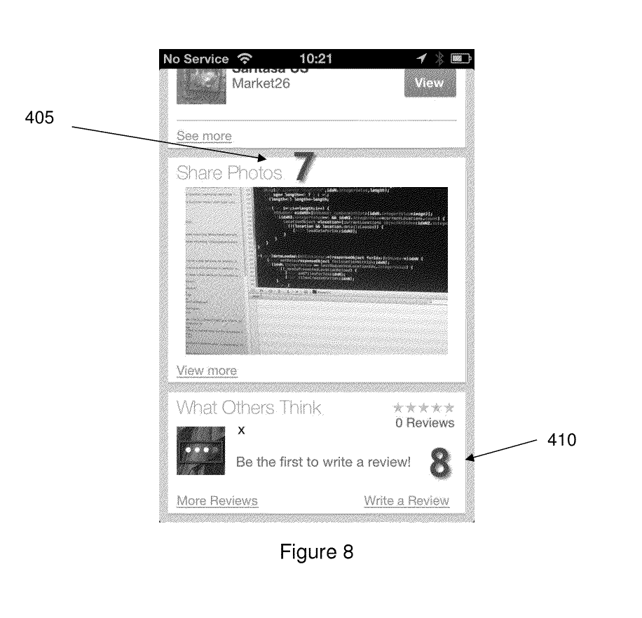

FIG. 4 illustrates an exemplary screenshot of the present invention illustrating the compass calibration feature of the present invention. The device compass is utilized to determine the heading of the mobile device. The user will need to ensure that the compass is properly calibrated to ensure that the application can determine the correct “places” results after taking a photo. The phone will recognize that the application is using the compass and ask the user to ensure calibration by waving the phone in a FIG. 8 pattern (310, also shown in the Figure at reference numeral 1). After calibration the user will then be able to start the inventive process of taking a picture to learn about places in front of them.

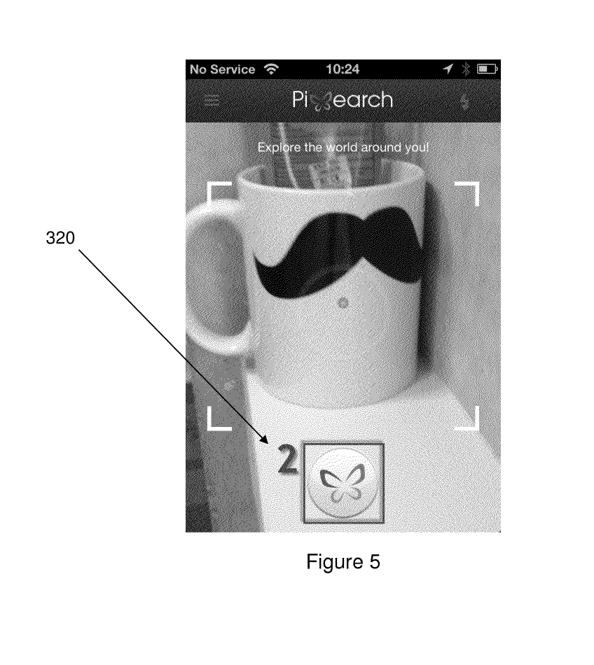

FIG. 5 illustrates an exemplary screenshot of the present invention illustrating the user interface for taking a photo. The user will point their camera at a place of interest and press the circular button to capture the photo (2, also shown in the Figure at reference numeral 320). This kicks off the process of collecting the location, heading and range details then communicates to the server to fetch results based upon the criteria. These details are fully explained within the Summary section above.

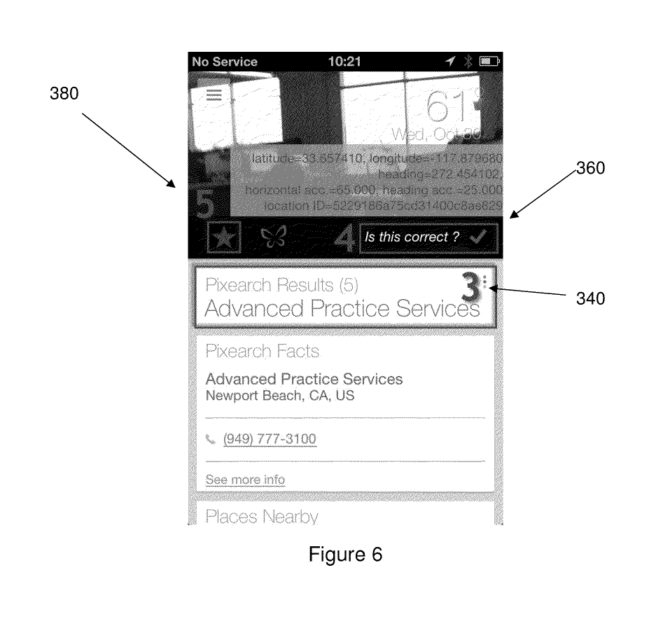

FIG. 6 illustrates an exemplary screenshot of the present invention illustrating how the present invention displays relevant search results. After collecting the results they are returned to the application for the user to view. In the illustrated example, the application returned five total results for the combination of location, heading and range. The user can swipe those results (right or left) to view each individually (340, also shown in the Figure at reference numeral 3). Each result provides details about the place. To confirm a result as the correct place in the photo taken by the user, the user will press the check mark (360, also shown in the Figure at reference numeral 4). The user can also save this to their favorites by pressing the star (380, also shown in the Figure at reference numeral 5). The location and heading details are shown in the image above as an example only; in another embodiment, the end user will not see these within their experience.

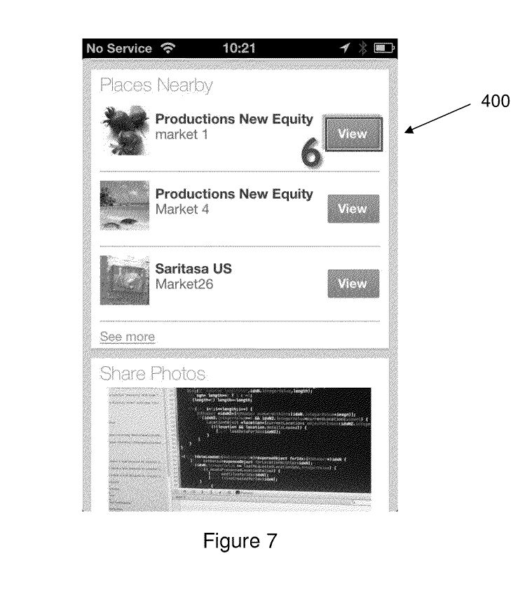

FIG. 7 illustrates an exemplary screenshot of the present invention illustrating an example of the additional details that are provided for a specific search result. The user can scroll (up or down) to view additional details about each place result. This example shows the ability to view other places that are near this result (400, also shown in the Figure at reference numeral 6) and to view photos of this result that have been taken by other users (also shown in FIG. 8, 405 at reference numeral 7).

FIG. 8 illustrates an exemplary screenshot of the present invention illustrating an example of reviews that may be attached to each result. The user can write a review (410, also shown in the Figure at reference numeral 8) for the place which will then be publicly available for other application users to see.

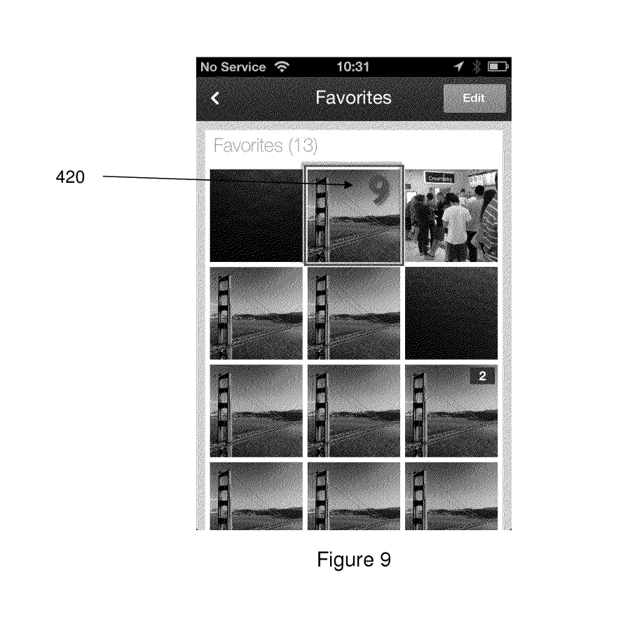

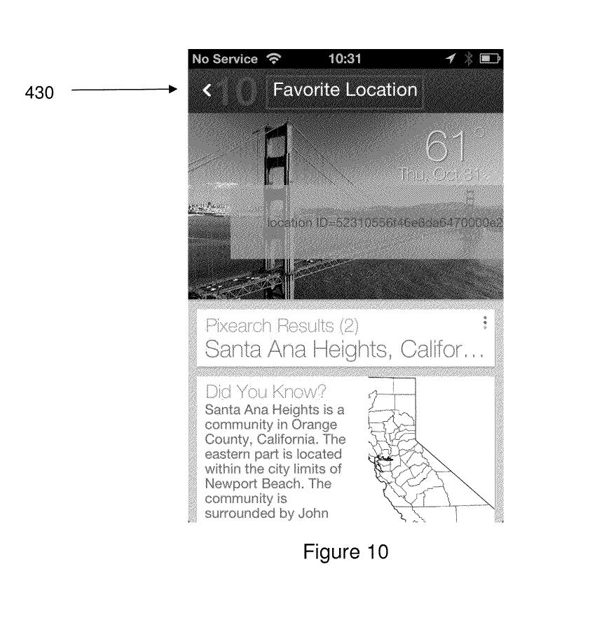

FIG. 9 illustrates an exemplary screenshot of the present invention illustrating how users can instruct the application to “favorite” each search result (420, also shown in the Figure at reference numeral 9). If the user indicates that a search result is a “favorite,” the application will save that image with the result details to the favorites screen to view later without the need to retake the photo. FIG. 10 illustrates an exemplary screenshot of the present invention illustrating how the user can press on a favorite image to view the details (430, also shown in the Figure at reference numeral 10) about the place in that image.

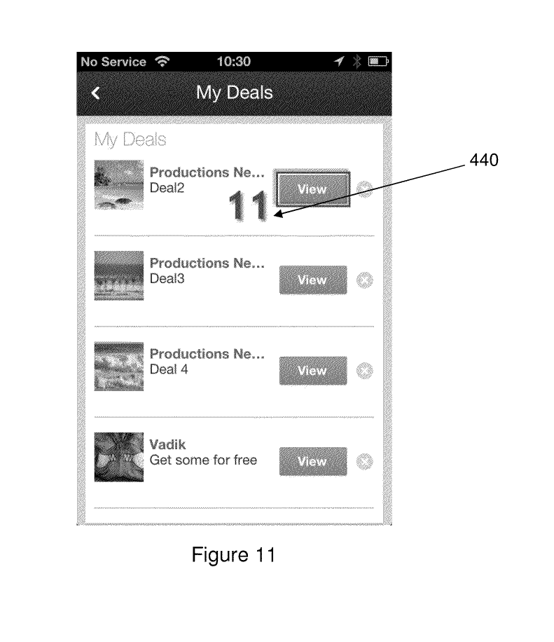

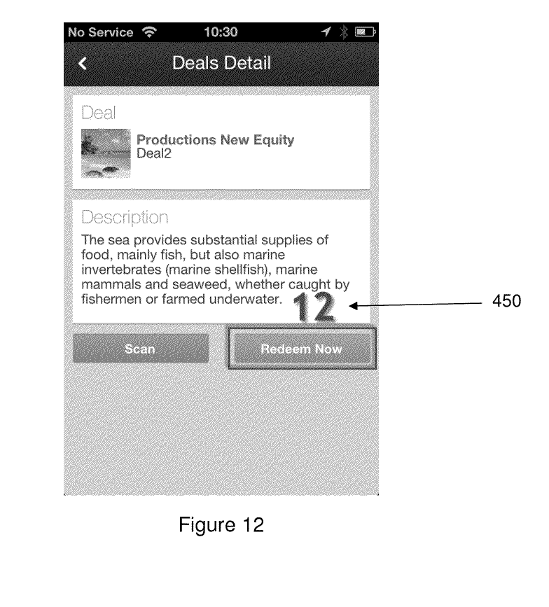

FIG. 11 illustrates an exemplary screenshot of the present invention illustrating deals from businesses displayed to the user. The “My Deals” screen (440, also shown in the Figure at reference numeral 11) displays the saved deals that are available to the user. This allows the user to save and redeem deals that are provided by subscribed businesses. FIG. 12 illustrates an exemplary screenshot of the present invention illustrating the deals detail screen where the user can redeem their deal (450, also shown in the Figure at reference numeral 12) at the business by scanning the application QR code at the counter.

While certain embodiments of the present invention are described in detail above, the scope of the invention is not to be considered limited by such disclosure, and modifications are possible without departing from the spirit of the invention as evidenced by the following claims.

What is claimed is:

1. A system for providing information relating to points of interest located in proximity to where a photo was taken, comprising:
a computer database for storing information, the database configured to store information relating to points of interest including businesses, the database adapted to store for each point of interest the location of the point of interest, and its name;
a server for receiving device location and heading information from a device used to take the photo, the server programmed with one or more software routines executing on the server to: 1) process the device location and heading information to search for points of interest within a predetermined range of the device location and heading; 2) collect information relating to the points of interest within the predetermined range of the device location and heading; 3) communicate the collected information relating to the points of interest to the device used to take the photo.

2. A system according to claim 1, wherein the server is programmed with one or more software routines executing on the server to search for points of interest within a predetermined radial range around the location of the device.

3. A system according to claim 2, wherein the server is programmed with one or more software routines executing on the server to search for points of interest within a predetermined range near the location of the device.

4. A system according to claim 2, wherein the server is programmed with one or more software routines executing on the server to search for points of interest within a predetermined conical shaped range near the location of the device, wherein the conical range starts from the location of the device and spreads out towards the direction of the heading of the device.

5. A system according to claim 3, wherein the range of the device location is between 0-500 meters.

6. A system according to claim 2, wherein the range of the device location is between 0-500 meters.

7. A system according to claim 1, wherein the server is programmed with one or more software routines executing on the server to accept confirmations from users for points of interest communicated to the devices.

8. A system according to claim 7, wherein the server is programmed with one or more software routines executing on the server to count the number of user confirmations for each point of interest.

9. A system according to claim 8, wherein the server is programmed with one or more software routines executing on the server to format the collected information relating to the points of interest to list the points of interest with the highest priority first.

10. A system according to claim 9, wherein the server is programmed with one or more software routines executing on the server to give the points of interest with the highest user confirmations the highest priority.

11. A system according to claim 1, wherein the server is programmed with one or more software routines executing on the server to accept registrations from businesses and to allow registered businesses to offer deals.

12. A system according to claim 11, wherein the server is programmed with one or more software routines executing on the server to collect information relating to businesses within the predetermined range of the device location and heading that are offering deals to users.

13. A system according to claim 11, wherein the server is programmed with one or more software routines executing on the server to collect information relating to businesses nearby the predetermined range of the device location and heading that are offering deals to users.

14. A system according to claim 1, wherein the server is programmed with one or more software routines executing on the server to call a third party interface to retrieve information relating to points of interest within a predetermined range of the device location and heading stored by the third party.

15. A system according to claim 1, wherein the server is programmed with one or more software routines executing on the server to allow users to indicate a point of interest as a favorite of the user, to save the photo taken, and to display the favorite point of interest with the saved photo each time the user views the favorite point of interest through the system.

16. A system for providing information relating to points of interest located in proximity to where a photo was taken, comprising:
a computer database for storing information, the database configured to store information relating to points of interest including businesses, the database adapted to store for each point of interest the location of the point of interest, and its name;
a server for receiving device location and heading information from a device used to take the photo, the server programmed with one or more software routines executing on the server to: 1) process the device location and heading information; 2) search for points of interest within a predetermined conical shaped range near the location of the device, wherein the conical range starts from the location of the device and spreads out towards the direction of the heading of the device; 3) collect information relating to the points of interest within the predetermined conical shaped range; 4) communicate the collected information relating to the points of interest to the device used to take the photo.

17. A system according to claim 16, wherein the server is programmed with one or more software routines executing on the server to search for points of interest within a predetermined radial range around the location of the device.

18. A system according to claim 17, wherein the server is programmed with one or more software routines executing on the server to search for points of interest within a predetermined range near the location of the device.

19. A system according to claim 18, wherein the range of the device location is between 0-500 meters.

20. A system according to claim 16, wherein the range of the device location is between 0-500 meters.

21. A system according to claim 16, wherein the server is programmed with one or more software routines executing on the server to accept confirmations from users for points of interest communicated to the devices.

22. A system according to claim 21, wherein the server is programmed with one or more software routines executing on the server to count the number of user confirmations for each point of interest.

23. A system according to claim 22, wherein the server is programmed with one or more software routines executing on the server to format the collected information relating to the points of interest to list the points of interest with the highest priority first.

24. A system according to claim 23, wherein the server is programmed with one or more software routines executing on the server to give the points of interest with the highest user confirmations the highest priority.

25. A system according to claim 16, wherein the server is programmed with one or more software routines executing on the server to accept registrations from businesses and to allow registered businesses to offer deals.

26. A system according to claim 25, wherein the server is programmed with one or more software routines executing on the server to collect information relating to businesses within the predetermined range of the device location and heading that are offering deals to users.

27. A system according to claim 25, wherein the server is programmed with one or more software routines executing on the server to collect information relating to businesses nearby the predetermined range of the device location and heading that are offering deals to users.

28. A system for providing information relating to points of interest located in proximity to where a photo was taken, comprising:
a computer database for storing information, the database configured to store information relating to points of interest including businesses, the database adapted to store for each point of interest the location of the point of interest, and its name;
a server for receiving device location and heading information from a device used to take the photo, the server programmed with one or more software routines executing on the server to: 1) process the device location and heading information; 2) search for points of interest within a predetermined radial range and conical shaped range near the location of the device, wherein the conical range starts from the location of the device and spreads out towards the direction of the heading of the device; 3) collect information relating to the points of interest within the predetermined conical shaped range; 4) communicate the collected information relating to the points of interest to the device used to take the photo.

29. A system according to claim 28, wherein the server is programmed with one or more software routines executing on the server to accept confirmations from users for points of interest communicated to the devices.

30. A system according to claim 29, wherein the server is programmed with one or more software routines executing on the server to count the number of user confirmations for each point of interest.

31. A system according to claim 30, wherein the server is programmed with one or more software routines executing on the server to format the collected information relating to the points of interest to list the points of interest with the highest priority first.

32. A system according to claim 31, wherein the server is programmed with one or more software routines executing on the server to give the points of interest with the highest user confirmations the highest priority.

33. A system according to claim 28, wherein the server is programmed with one or more software routines executing on the server to accept registrations from businesses and to allow registered businesses to offer deals.

34. A system according to claim 33, wherein the server is programmed with one or more software routines executing on the server to collect information relating to businesses within the predetermined range of the device location and heading that are offering deals to users.
